(19) United States
(12) Patent Application Publication
(10) Pub. No.: US 2026/0008679 A1
(43) Pub. Date: Jan. 8, 2026

(54) ANODE MATERIAL, NEGATIVE ELECTRODE PLATE AND SECONDARY BATTERY

(71) Applicant: BTR NEW MATERIAL GROUP CO., LTD., Shenzhen (CN)

(72) Inventors: Ruiyang WANG, Shenzhen (CN); Tao XU, Shenzhen (CN); Jianshuo ZHANG, Shenzhen (CN); Haihui ZHOU, Shenzhen (CN); Peng HE, Shenzhen (CN); Youyuan HUANG, Shenzhen (CN); Xueqin HE, Shenzhen (CN)

(73) Assignee: BTR NEW MATERIAL GROUP CO., LTD., Shenzhen (CN)

(21) Appl. No.: 19/323,418

(22) Filed: Sep. 9, 2025

(30) Foreign Application Priority Data
Dec. 16, 2024 (CN) 202411850897.7

(51) Int. Cl. C01B 32/22; H01M 10/0525

(52) U.S. Cl. CPC C01B 32/22; H01M 10/0525; C01P 2002/08; C01P 2004/03; C01P 2004/32; C01P 2004/61; C01P 2006/10; C01P 2006/11; C01P 2006/12; C01P 2006/40

(57) ABSTRACT

Provided is an anode material, a negative electrode plate and a secondary battery, and relates to the technical field of secondary batteries. The anode material includes natural graphite and amorphous carbon filled in pores of the natural graphite; a particle hardness of the anode material is 0.28 GPa-0.4 GPa, and an elastic modulus is 7.0 GPa-8.0 GPa; and when a tablet compaction density of the anode material is 1.5 g/cm³-2.0 g/cm³, a tablet orientation OI value of the anode material is y, and 4<y≤11. When the anode material is used in the secondary battery, initial coulombic efficiency and cycle stability can be significantly improved.

### CROSS-REFERENCE TO RELATED APPLICATION

The present application claims the priority of a Chinese patent application No. 202411850897.7 filed on Dec. 16, 2024. The entire contents of the Chinese patent application are incorporated into the present application by reference.

### TECHNICAL FIELD

The present application relates to the technical field of secondary batteries, and specifically relates to an anode material, a negative electrode plate and a secondary battery.

### BACKGROUND

Lithium-ion batteries have been widely used in the fields of 3C, power devices and energy storage equipment due to the advantages of a low self-discharge rate, high charge-discharge efficiency, no memory effect, a long cycle life and the like. The performance of anode materials, as important components of the lithium-ion batteries, directly affects the electrochemical performance of the lithium-ion batteries. Natural graphite anode materials have been widely concerned due to the advantages of a higher specific capacity, a low charge-discharge platform, a low cost and the like. However, natural graphite has higher anisotropy and internal defects and is prone to undergoing solvent co-intercalation during intercalation of lithium ions, leading to decrease of the stability of a solid electrolyte interphase (SEI) membrane, consumption of additional lithium ions and decrease of initial coulombic efficiency. Moreover, due to such higher contents of defects, the graphite undergoes uneven volume expansion. During long-term cycles of the lithium-ion batteries, the continuous expansion and contraction of a graphite structure may lead to further expansion of a defect area, even lead to shedding of graphite sheet layers and formation of cracks, and result in capacity attenuation in the long-term cycles.

### SUMMARY

A primary objective of the present application is to provide an anode material, a negative electrode plate and a secondary battery to solve the problems of low initial coulombic efficiency and insufficient cycle stability of anode materials during charging and discharging in the prior art.

To achieve the above objective, according to one aspect of the present application, an anode material is provided. The anode material includes natural graphite and amorphous carbon filled in pores of the natural graphite: a particle hardness of the anode material is 0.28 GPa-0.4 GPa, and an elastic modulus is 7.0 GPa-8.0 GPa; and when a tablet compaction density of the anode material is 1.5 g/cm³-2.0 g/cm³, a tablet orientation OI value of the anode material is y, and 4<y≤11.

Further, the anode material satisfies at least one of the following characteristics:
(1) the particle hardness of the anode material is any value within any range of 0.28 GPa-0.295 GPa, 0.296 GPa-0.307 GPa, 0.308 GPa-0.356 GPa, 0.357 GPa-0.393 GPa, and 0.394 GPa-0.4 GPa;
(2) the elastic modulus of the anode material is any value within any range of 7.0 GPa-7.15 GPa, 7.16 GPa-7.26 GPa, 7.27 GPa-7.45 GPa, 7.46 GPa-7.78 GPa, and 7.79 GPa-8.0 GPa;
(3) when the tablet compaction density of the anode material is 1.5 g/cm³-2.0 g/cm³, the tablet orientation OI value of the anode material is any value within any range of 4.01-5.4, 5.53-6.58, 6.62-7.38, 7.94-8.51, 8.67-9.73, 9.74-10, and 10-11;
(4) the particle hardness of the anode material is 0.28 GPa, 0.287 GPa, 0.288 GPa, 0.295 GPa, 0.308 GPa, 0.335 GPa, 0.356 GPa, 0.393 GPa, 0.4 GPa or any value within any range comprised of two of the aforementioned values;
(5) the elastic modulus of the anode material is 7.0 GPa, 7.08 GPa, 7.15 GPa, 7.26 GPa, 7.45 GPa, 7.78 GPa, 7.9 GPa, 7.96 GPa, 8.0 GPa or any value within any range comprised of two of the aforementioned values; and
(6) when the tablet compaction density of the anode material is 1.5 g/cm³-2.0 g/cm³, the tablet orientation OI value of the anode material is 4.05, 4.48, 4.68, 5.4, 5.53, 5.92, 6.1, 6.31, 6.58, 6.62, 7.38, 7.94, 8.11, 8.46, 8.51, 8.67, 9.73, 10, 11 or any value within any range comprised of two of the aforementioned values.

Further, the tablet orientation OI value y of the anode material at different tablet compaction densities satisfies that y₁≤y≤y₂,
wherein y₁=5.46x−3.78, y₂=8.9x−7.76, 1.5≤x≤2.0, and x is a numerical value corresponding to the tablet compaction density of the anode material.

Further, when the tablet compaction density of the anode material is 1.5 g/cm³-2.0 g/cm³, the tablet orientation OI value of the anode material is 5-10.

Further, the anode material satisfies at least one of the following characteristics:
(1) a sphericity Sh(90%) of the anode material is 0.90-0.95;
(2) a D50 volume-average particle size of the anode material is 8 μm-18 μm; and
(3) an equal volume-average particle size of the anode material is 10 μm-20 μm.

Further, a shape coefficient of the anode material is φ, and the sphericity Sh(90%) of the anode material satisfies that Δ=|φ−Sh(90%)|, and Δ≤0.08, wherein φ=D1/D2, D1 is the D50 volume-average particle size of the anode material with the unit of μm, and D2 is the equal volume-average particle size of the anode material with the unit of μm.

Further, a specific surface area of the anode material is 2 m²/g-5 m²/g.

Further, a tap density of the anode material is 0.9 g/cm³-1.3 g/cm³.

Further, a powder compaction density of the anode material is 1.7 g/cm³-2.0 g/cm³.

A second aspect of the present application provides a negative electrode plate, wherein the negative electrode plate includes the anode material provided in the first aspect.

A third aspect of the present application provides a secondary battery, wherein the secondary battery includes the negative electrode plate provided in the second aspect.

By applying technical solutions of the present application, a densification degree of the anode material is improved, and the anisotropy of the anode material can be reduced, thereby promoting more uniform diffusion of lithium ions in different directions and facilitating improvement of the electrochemical performance of the anode material. Meanwhile, by limiting the particle hardness of the anode material to 0.28 GPa-0.4 GPa, the elastic modulus to 7.0 GPa-8.0 GPa and the tablet orientation OI value y to 4<y≤11, the structural stability of the anode material can be enhanced to effectively control volume expansion, it is ensured that the structural stability of the anode material can be maintained during charging and discharging, and meanwhile, it is ensured that the surface and interior of the anode material have smooth lithium-ion channels to reduce the problems of shedding of sheet layers and formation of cracks, thereby improving the cycle stability. When the anode material is used in the secondary battery, the initial coulombic efficiency can be ≥94%, and a capacity retention rate is ≥92.5% after 400 cycles.

### BRIEF DESCRIPTION OF THE DRAWINGS

FIG. 1 is a structural schematic diagram of a secondary battery provided in one embodiment of the present application during charging;

FIG. 2 is a structural schematic diagram of a secondary battery provided in one embodiment of the present application during discharging:

FIG. 3 is a coordinate graph of tablet orientation OI values of anode materials at different compaction densities in examples and comparative examples of the present application; and

FIG. 4 is an SEM image of an anode material in Example 1 of the present application:

### REFERENCE NUMERALS IN THE DRAWINGS ARE DESCRIBED AS FOLLOWS

100—electrode assembly; 101—positive electrode plate; 102—negative electrode plate; 103—diaphragm.

### DETAILED DESCRIPTION OF THE EMBODIMENTS

In order to make the objectives, technical solutions and advantages of the examples of the present application clearer, the technical solutions in the examples of the present application are described clearly and completely below. Those without specific conditions in the examples are used in accordance with conventional conditions or conditions recommended by manufacturers. All reagents or instruments used without specific manufacturers are conventional products that can be purchased on the market.

As described in the background of the present application, anode materials have the problems of low initial coulombic efficiency and insufficient cycle stability during charging and discharging in the prior art. To solve the above problems, in one typical embodiment of the present application, an anode material is provided. The anode material includes natural graphite and amorphous carbon filled in pores of the natural graphite; a particle hardness of the anode material is 0.28 GPa-0.4 GPa, and an elastic modulus is 7.0 GPa-8.0 GPa; and when a tablet compaction density of the anode material is 1.5 g/cm³-2.0 g/cm³, a tablet orientation OI value of the anode material is y, and 4<y≤11.

The anode material includes the natural graphite and the amorphous carbon filled in the pores of the natural graphite, such that a densification degree of the anode material is improved. Meanwhile, since the amorphous carbon has a high disorder property; the filling of the amorphous carbon can reduce the anisotropy of the anode material, thereby making more uniform diffusion of lithium ions in different directions and facilitating improvement of the electrochemical performance of the anode material.

The particle hardness and elastic modulus of the anode material are crucial to the electrochemical performance and cycle stability of a secondary battery, which can also reflect the densification degree and the amorphous carbon filling degree in particles. The particle hardness (HIT) of the anode material directly reflects an ability of the graphite particles to resist elastic deformation and plastic deformation under the action of an external force. The clastic modulus (EIT) of the anode material reflects an ability of the anode material to resist the action of an external force at an elastic deformation stage, that is, a stress of the material required to produce a unit strain under a force.

The particle hardness of the anode material affects volume expansion and a contraction degree of the anode material. By limiting the particle hardness of the anode material to 0.28 GPa-0.4 GPa, the graphite particles have sufficient mechanical strength to bear the volume expansion and contraction generated during intercalation and deintercalation of lithium ions, that is, the mechanical stress during the process can be better resisted, and convenience is provided for reducing fragmentation and shedding of the particles in a cycle process, thereby improving the cycle stability. Secondly; convenience is provided for limiting the expansion of the pores in the particles and decreasing the probability of co-intercalating of electrolyte solvent molecules and lithium ions between graphite layers, thereby reducing excessive consumption of a SEI membrane and improving the initial coulombic efficiency. In addition, during a charge-discharge cycle of a secondary battery; the graphite particles undergo repeated volume changes. When the particle hardness is 0.28 GPa-0.4 GPa, convenience is provided for maintaining the structural integrity of the anode material, reducing capacity attenuation caused by mechanical wear and structural damage and prolonging the service life of the secondary battery. Specifically but not restrictively; the particle hardness of the anode material is any value within any range of 0.28 GPa-0.295 GPa. 0.296 GPa-0.307 GPa, 0.308 GPa-0.356 GPa. 0.357 GPa-0.393 GPa, and 0.394 GPa-0.4 GPa; or the particle hardness of the anode material is 0.28 GPa. 0.287 GPa. 0.288 GPa. 0.295 GPa, 0.308 GPa, 0.335 GPa, 0.356 GPa, 0.393 GPa. 0.4 GPa or any value within any range comprised of two of the aforementioned values.

The elastic modulus of the anode material is related to stress-strain performance of the anode material. By limiting the elastic modulus of the anode material to 7.0 GPa-8.0 GPa, it is indicated that the elastic deformation of the anode material generated during the intercalation and deintercalation of the lithium ions can be better controlled, so that the volume changes of the anode material during the cycle process are effectively alleviated, the anode material can better adapt to the volume changes, cracks and particle shedding caused by stress concentration are reduced, and convenience is provided for improving the cycle stability. Secondly, convenience is provided for stabilizing the SEI membrane during the charge-discharge cycle, and membrane rupture caused by material expansion is reduced, thereby improving the initial coulombic efficiency and the cycle performance. In addition, the elastic modulus is related to diffusion kinetics of the lithium ions in the anode material. An appropriate elastic modulus means that the material has lower internal stress, the lithium ions have more smooth diffusion paths, and convenience is provided for increasing a transport rate of the lithium ions, thereby improving the electrochemical performance, such as a charge-discharge rate and a capacity, of a secondary battery. Specifically but not restrictively, the elastic modulus of the anode material is any value within any range of 7.0 GPa-7.15 GPa, 7.16 GPa-7.26 GPa, 7.27 GPa-7.45 GPa, 7.46 GPa-7.78 GPa, and 7.79 GPa-8.0 GPa; or the elastic modulus of the anode material is 7.0 GPa, 7.08 GPa, 7.15 GPa, 7.26 GPa, 7.45 GPa, 7.78 GPa, 7.9 GPa, 7.96 GPa, 8.0 GPa or any value within any range comprised of two of the aforementioned values.

The anode material has diffraction peaks corresponding to (004) crystal plane and (110) crystal plane in an X-ray diffraction pattern, and the tablet orientation OI value of the anode material is a ratio of a diffraction peak area of a formed tablet on the (004) crystal plane to a diffraction peak area on the (110) crystal plane. In some examples, when the tablet compaction density of the anode material is 1.5 g/cm³-2.0 g/cm³, the tablet orientation OI value of the anode material is y, and 4<y≤11. The tablet orientation OI value is a parameter that describes an order degree of arrangement of graphite sheet layers in the anode material. By limiting the tablet orientation OI value y to 4<y≤11, convenience is provided for improving the kinetic performance of the material. Since the amorphous carbon has the high disorder property, the filling of the amorphous carbon can decrease the tablet orientation OI value. Such disorder property is conducive to preventing the co-intercalation of a solvent in an electrolyte solution into the graphite layers, thereby improving the interface transport kinetic performance of the lithium ions. In the present application, by limiting the tablet orientation OI value within the above range, convenience is provided for improving the initial coulombic efficiency and cycle stability of the anode material. Specifically but not restrictively, when the tablet compaction density of the anode material is 1.5 g/cm³-2.0 g/cm³, the tablet orientation OI value of the anode material is any value within any range of 4.01-5.4, 5.53-6.58, 6.62-7.38, 7.94-8.51, 8.67-9.73, 9.74-10, and 10-11; or the tablet orientation OI value of the anode material is 4.05, 4.48, 4.68, 5.4, 5.53, 5.92, 6.1, 6.31, 6.58, 6.62, 7.38, 7.94, 8.11, 8.46, 8.51, 8.67, 9.73, 10, 11 or any value within any range comprised of two of the aforementioned values.

In the present application, by limiting the particle hardness of the anode material to 0.28 GPa-0.4 GPa, the elastic modulus to 7.0 GPa-8.0 GPa and the tablet orientation OI value y to 4<y≤11, not only can the high densification degree and high amorphous carbon filling degree in the particles be reflected, but also a balance between the structural stability and the transport kinetics of the lithium ions can be achieved, thereby improving both the initial coulombic efficiency and the cycle stability. Specifically, on the one hand, the structural integrity of the anode material during the cycle process is ensured, thereby improving the cycle stability; and on the other hand, the diffusion paths of the lithium ions in the anode material are optimized, thereby being conducive to improving the electrochemical performance, such as the initial coulombic efficiency. Such synergistic effect is conducive to maintaining the moderate elastic deformation of the anode material during the intercalation and deintercalation of the lithium ions, avoiding excessive plastic deformation, and maintaining the more stable SEI membrane and better electrochemical performance, thereby improving both the initial coulombic efficiency and the cycle stability.

The particle hardness and elastic modulus of the anode material can be determined through an indentation hardness test, and can be measured by using, for example, a nanoindenter. During the test, a hard indenter is used to press surfaces of the particles with a certain force and then is unloaded. A hardness value of the anode material is calculated by measuring the depth and width of an indentation and the magnitude of the applied force. The elastic modulus is calculated by measuring an unloading process of the indentation on a surface of the material. At least 10 particles are tested for each sample. After the test, mean values of the hardness value and the elastic modulus are taken respectively, which are the particle hardness and elastic modulus of the anode material.

According to research of the present application, when the above anode material is used in a secondary battery, the initial coulombic efficiency and the cycle stability can be significantly improved. This is because on the one hand, due to the amorphous carbon in the pores of the natural graphite in the anode material of the present application, the densification degree of the anode material is improved, and the anisotropy of the anode material can be reduced, thereby making more uniform diffusion of the lithium ions in different directions and facilitating improvement of the electrochemical performance of the anode material; and on the other hand, by limiting the particle hardness of the anode material to 0.28 GPa-0.4 GPa, the elastic modulus to 7.0 GPa-8.0 GPa and the tablet orientation OI value y to 4<y≤11, not only are the high densification degree and the high amorphous carbon filling degree in the particles indicated, but also the anode material has appropriate mechanical strength and a deformation ability, which can both resist the volume changes during charging and discharging and optimize the transport kinetics of the lithium ions, thereby improving the stability of the SEI membrane and the overall performance of the secondary battery. When the anode material is used in the secondary battery, the initial coulombic efficiency can be >94%, and a capacity retention rate is ≥92.5% after 400 cycles, thereby being conducive to obtaining the secondary battery with higher efficiency, higher stability and a longer service life.

In some preferred examples, the tablet orientation OI value y of the anode material at different tablet compaction densities satisfies that y₁y≤y₂, wherein y₁=5.46x−3.78, y₂=8.9x−7.76, 1.5≤x≤2.0, and x is a numerical value corresponding to the compaction density of the anode material; and y₂ and y₁ are an upper limit and a lower limit of the tablet orientation OI value at different compaction densities, respectively. By limiting the tablet orientation OI value of the anode material and the tablet compaction density to meet the above requirements, the high isotropy of the anode material can be ensured, a small polarization effect during charging is ensured, a volume effect is limited, and the formation of new SEI is reduced. In addition to further improving the initial coulombic efficiency and the cycle stability, the capacity can also be exerted to a maximum degree, thereby improving all the initial coulombic efficiency, capacity and cycle stability of the anode material.

Specifically, when the tablet compaction density of the anode material is 1.5 g/cm³, that is, when x is 1.5, y₁=4.41, y₂=5.59, at this time, 4.41<y≤5.59, and the tablet orientation OI value is 4.41-5.59. When the tablet compaction density of the anode material is 2 g/cm³, that is, when x is 2, y₁=7.14, y₂=10.04, at this time, 7.14<y≤10.04, and the tablet orientation OI value is 7.14-10.04, and so on. In a specific implementation process of the present application, the tablet compaction density of the anode material essentially refers to the compaction density of a tablet formed by the anode material at different pressures.

In some preferred examples, the tablet orientation OI value y of the anode material at different tablet compaction densities satisfies that y₁<y≤y₂, wherein y₁=5.46x−3.78, and y₂=8.88x−8.

In some preferred examples, the tablet orientation OI value of the anode material is 5-10, preferably 5-9, which can further improve the initial coulombic efficiency and cycle stability of the anode material.

A geometric form of the particles of the anode material has a certain impact on the electrochemical performance and the cycle stability. The geometric form of the particles affects a contact area with the electrolyte solution and the mechanical stability during charging and discharging, thereby affecting the charge-discharge performance and cycle stability of the secondary battery. In some examples, a shape coefficient of the anode material is p, and the sphericity Sh(90%) of the anode material satisfies that Δ=|φ−Sh(90%)|, and Δ≤0.08, wherein φ=D1/D2, D1 is a D50 volume-average particle size of the anode material with the unit of μm, and D2 is an equal volume-average particle size of the anode material with the unit of μm. Specifically, Δ=|φ−Sh(90%)|, and it can be understood that Δ is an absolute value of a difference between φ and Sh(90%). By limiting the shape coefficient φ of the anode material and the sphericity Sh(90%) of the anode material to satisfy the above relation formula, excellent contact between the particles can be ensured, and meanwhile, it is ensured that the particles have good mechanical stability and can resist the volume expansion and the contraction, thereby improving the charge-discharge performance and cycle stability of the secondary battery. In some preferred embodiments, Δ≤0.06, which can further improve the charge-discharge performance and the cycle stability.

The sphericity refers to a degree to which the particles are similar to spheres. The sphericity Sh(90%) of the anode material refers to the sphericity corresponding to the 90% of the frequency cumulative distribution in the sphericity-frequency cumulative distribution curve. The ratio closer to 1 represents that the particles are more similar to perfect spherical shapes. In some examples, the sphericity Sh(90%) of the anode material is 0.90-0.95, which means that most of the graphite particles have higher sphericity. In addition to being conducive to further improving the initial coulombic efficiency and cycle stability of the secondary battery, the geometric form is conducive to forming a denser structure during compaction, thereby facilitating increase of the energy density of the secondary battery. In addition, the spherical graphite particles have isotropy, which can form more uniform lithium ion transport paths and a more stable conductive network. Compared with irregularly shaped particles, the spherical particles are arranged more orderly in an electrode, which can reduce the transport resistance of electrons and lithium ions in the secondary battery and increase the charge-discharge rate and capacity of the secondary battery.

The D50 volume-average particle size refers to the corresponding particle size when the percentage of cumulative volume distribution in a sample reaches 50%, which reflects the average particle size of the anode material. In some examples, the D50 volume-average particle size of the anode material is 8 μm-18 μm. The equal volume-average particle size refers to the average particle size of spheres with same average volume as the particles. In some examples, the equal volume-average particle size of the anode material is 10 μm-20 μm. By limiting the D50 volume-average particle size and equal volume-average particle size of the anode material within appropriate ranges, in addition to being conducive to further improving the initial coulombic efficiency and cycle stability of the secondary battery, the diffusion paths of the lithium ions can be shorter, and the transport resistance of the lithium ions during the intercalation and the deintercalation can be reduced, thereby improving the charge-discharge efficiency. In addition, internal pores of an electrode can also be reduced to improve the energy density of the secondary battery. In some preferred examples, the D50 volume-average particle size of the anode material is 10 μm-18 m, and the equal volume-average particle size is 11 μm-18 μm.

Specific surface area (SSA) refers to a total surface area of a material per unit mass. In some examples, a specific surface area of the anode material is 2 m²/g-5 m²/g. By limiting the specific surface area of the anode material within an appropriate range, in addition to further improving the initial coulombic efficiency and the cycle performance, moderate diffusion paths can also be provided, which not only avoids performance decrease caused by an electrolyte solution penetrating deep into the internal pores of the material, but also facilitates rapid and uniform diffusion of the lithium ions during charging and discharging, thereby improving the rate performance and cycle stability of the secondary battery. In addition, the contact between the electrolyte solution and the surface of the graphite material can be reduced, thereby decreasing the possibility of side reactions, such as decomposition of the electrolyte solution, co-intercalation of solvent molecules, etc.

Tap density (Tap) refers to a compact degree of a material under physical vibration. In some examples, a tap density of the anode material is 0.9 g/cm³-1.3 g/cm³. By limiting the tap density of the anode material within an appropriate range, convenience is provided for increasing the compaction density of the material during manufacturing of an electrode, reducing internal pores of the electrode, and improving the utilization rate of the anode material and the energy density of the secondary battery. Meanwhile, a contact area between the electrolyte solution and the graphite particles can be reduced, thereby reducing the formation of the SEI membrane, decreasing the irreversible capacity during initial charging and discharging, and improving the initial coulombic efficiency. Convenience is also provided for reducing the volume expansion during the cycle process, decreasing the mechanical stress between the particles, and preventing the formation of cracks, thereby improving the cycle stability. In addition, convenience is provided for maintaining the structural integrity of the electrode and preventing an active substance from falling from a current collector, thereby further improving the cycle performance. In some preferred examples, the tap density of the anode material is 1 g/cm³-1.3 g/cm³.

Powder compaction density refers to the density of anode material powder at a certain pressure (e.g., 2 T), which is usually determined by compacting the material at a certain pressure and then measuring the volume and mass of the compacted material. The powder compaction density is directly related to the energy density, initial coulombic efficiency and cycle stability of the secondary battery. In some examples, a powder compaction density of the anode material is 1.7 g/cm³-2.0 g/cm³. By limiting the powder compaction density within an appropriate range, closer contact of the graphite particles can be achieved, which is conducive to forming the more uniform and stable SEI membrane, thereby further improving the initial coulombic efficiency. Meanwhile, relative movement between the particles is decreased, and the mechanical stress borne by the graphite particles during the charge-discharge cycle is reduced, thereby further improving the cycle stability. In addition, the anode material can be distributed more uniformly, which is conducive to improving the energy density.

The anode material of the present application can be used as an anode material in a secondary battery, which can effectively improve the initial coulombic efficiency and cycle stability of the secondary battery. For example, in some examples, the initial coulombic efficiency of the anode material is above 94%, and the capacity retention rate after 400 cycles is ≥92.5%. The capacity is ≥360 mAh/g.

A specific preparation process of the anode material is not limited in the present application, only ensuring that the above parameters are met. In some examples, a method for preparing the above anode material includes the following steps:
S1, subjecting a graphite raw material to oxidation treatment to obtain graphite oxide;
S2, subjecting the graphite oxide and asphalt to mixed coating and first heat treatment to obtain a complex;
S3, subjecting the complex to densification treatment to obtain an intermediate product; and
S4, subjecting the intermediate product to second heat treatment to obtain the anode material.

Specifically, in the S1, the graphite raw material is subjected to the oxidation treatment, which can effectively improve the surface activity of the graphite raw material, and can not only promote the uniformity in a subsequent coating process, but also facilitate improvement of the compatibility and stability of the material for an electrolyte solution, thereby achieving mechanical properties matched with intercalation/deintercalation of lithium ions.

The specific temperature, gas content and time of the oxidation treatment can be adjusted according to actual situations. For example, in some examples, the graphite raw material may be natural graphite, the natural graphite may be, for example, spherical graphite, and a D50 volume-average particle size of the spherical graphite is 1 μm-20 μm. The particle size range can ensure the uniformity and stability of the material during subsequent treatment. The oxidation treatment may be carried out under the condition of an oxygen volume content of 10%-10%, a temperature of the oxidation treatment is 400° C.-600° C., and a time is 2 h-3 h.

In the S2, the graphite oxide and the asphalt are subjected to the mixed coating. It can be understood that the graphite oxide and the asphalt are mixed under normal temperature conditions, and during the mixed coating, the asphalt and the graphite oxide are evenly mixed to obtain a mixture; and the mixture is subjected to the first heat treatment to make the asphalt in a molten state to be filled into pores in the graphite to obtain the complex. Through the mixed coating and the first heat treatment, convenience is provided for improving the compactness, densification degree and hardness of the material.

A specific mixing ratio of the graphite oxide to the asphalt can be adjusted according to characteristics and demands of the material. For example, in some examples, a mass ratio of the graphite raw material to the asphalt is 100:(1-30); the asphalt is selected from at least one of petroleum asphalt, coal tar pitch, and mesophase pitch, and a D50 volume-average particle size of the asphalt is 2 μm-3 m; and a softening point of the asphalt is 100° C.-300° C., and a time of the mixed coating is 10 min-60 min. The first heat treatment may be carried out under the conditions of a first inert atmosphere at a temperature higher than the softening point of the asphalt. The first inert atmosphere is used for preventing oxidation of the material during the heat treatment process. Any inert gas can achieve the purpose. For example, the first inert atmosphere may include at least one of nitrogen, helium, and argon. A temperature of the first heat treatment is 200° C.-600° C., and a time is 3 h-4 h.

In the S3, the densification treatment includes press forming treatment and isostatic pressing treatment. Specifically, the complex is first subjected to press forming by a hydraulic press to obtain a press forming product; then, the press forming product is subjected to the isostatic pressing treatment to obtain an isostatic pressing product; and finally, the isostatic pressing product is subjected to crushing treatment to obtain the intermediate product. Through the densification treatment, internal pores of the graphite can be effectively reduced, the density of the material can be increased, the structural compactness can be enhanced, and a pore filling effect can be improved, so that the particle hardness and elastic modulus of the material can meet the above requirements.

The specific pressure, time and cycle number of the press forming treatment can be adjusted according to actual equipment capacities and material requirements. For example, in some examples, conditions for the press forming are as follows: a pressure of the hydraulic press is 10 MPa-40 MPa, a pressure holding time is 0-2 min, and slow reciprocating treatment is carried out for 2-4 times after the pressure is relieved for 0.5 min. The short pressure holding time can ensure that the material quickly forms a dense structure at high pressure while avoiding equipment wear and decreased production efficiency caused by long-term pressure holding, which is suitable for a continuous production process and can improve the production efficiency and an equipment utilization rate. The isostatic pressing treatment can further improve the density and structural stability of the material, and the specific pressure and the time can be optimized according to performance requirements of the material and equipment capacities. For example, in some examples, in the isostatic pressing treatment, a filling effect of the asphalt in the graphite can be regulated by adjusting the pressure. For example, the isostatic pressing treatment can adopt cold isostatic pressing treatment or warm isostatic pressing treatment, a pressure of the isostatic pressing treatment is 60 MPa-120 MPa, and a pressure holding time is 1 min-60 min.

In the S4, the intermediate product is subjected to the second heat treatment under a second inert atmosphere to ensure the degree of graphitization of the material, and scattering, demagnetization and screening are carried out after the second heat treatment to obtain the anode material. The asphalt is converted into amorphous carbon through the second heat treatment, thereby ensuring stable carbonization of the material at high temperature and improving the degree of graphitization. An appropriate heat treatment temperature and an appropriate time can affect the crystallinity and microstructure of the graphite, thereby making the hardness and elastic modulus of the material meet the above requirements.

The specific temperature and time of the second heat treatment can be adjusted according to conditions of a heat treatment device and performance targets of the material. For example, in some examples, the temperature of the second heat treatment is greater than that of the first heat treatment. For example, the temperature of the second heat treatment is 900° C.-1,600° C., and the time is 10 h-24 h. The second inert atmosphere is used for preventing oxidation of the material during the heat treatment process. Any inert gas can achieve the purpose. For example, the second inert atmosphere may include at least one of nitrogen, helium, and argon.

A second aspect of the present application provides a negative electrode plate, wherein the negative electrode plate includes the anode material provided in the first aspect.

The negative electrode plate of the present application includes a negative current collector and an anode active material layer arranged on at least one surface of the negative current collector. The anode active material layer includes the anode material provided in the first aspect. The negative current collector may use at least one of copper foil, nickel foil, stainless steel foil, titanium foil, or a carbon-based current collector, etc., and may also be any composite current collector disclosed in the prior art, for example, but not limited to, a current collector formed by combination of the aforementioned conductive foil and a polymer substrate. Since the anode material with excellent performance is included, when the negative electrode plate is used in a secondary battery, convenience is provided for improving the initial coulombic efficiency and cycle stability of the secondary battery.

The anode active material layer further includes a binder that is used for bonding anode active substance particles to facilitate the formation of a membrane layer and can also improve a binding force between the anode active material layer and the negative current collector. In some examples, the binder may include, but is not limited to, polyvinyl alcohol, hydroxypropyl cellulose, diacetyl cellulose, polyvinyl chloride, carboxylated polyvinyl chloride, polyvinyl fluoride, ethylene oxide containing polymers, polyvinylpyrrolidone, polyurethane, polytetrafluoroethylene, polyvinylidene fluoride, polyethylene, polypropylene, styrene-butadiene rubber, acrylic (ester) styrene-butadiene rubber, epoxy resin, or nylon, etc.

The anode active material layer may further include a conductive material, and the conductive material includes, but is not limited to, a carbon-based material, a metal-based material, a conductive polymer, or any combination thereof. In some examples, the carbon-based material may include, but is not limited to, natural graphite, artificial graphite, carbon black, acetylene black, Ketjen black, a carbon fiber, or any combination thereof. In some examples, the metal-based material may include, but is not limited to, metal powder or a metal fiber, such as copper, nickel, aluminum, or silver. In some examples, the conductive polymer may be a polyphenylene derivative.

When the negative electrode plate is prepared specifically, the anode material, the conductive agent and the binder can be dispersed in an appropriate amount of a solvent and thoroughly stirred and mixed to form a uniform negative slurry; and the negative slurry is evenly coated on the negative current collector and subjected to drying, rolling and cutting to obtain the negative electrode plate. In one specific embodiment, the anode active material layer includes, by mass percentage, 70%-99% of the anode material, 0.5%-15% of the conductive agent, and 0.5%-15% of the binder.

The conductive agent may be selected from at least one of natural graphite, artificial graphite, carbon black, acetylene black, Ketjen black, a carbon fiber, and graphene; and the binder may be selected from at least one of carboxymethyl cellulose, styrene-butadiene rubber, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, polyvinyl alcohol, and sodium polyacrylate.

A third aspect of the present application provides a secondary battery, wherein the secondary battery includes the negative electrode plate provided in the second aspect. Since the above negative electrode plate with excellent performance is included, the secondary battery has excellent initial coulombic efficiency and cycle stability.

Specifically, the secondary battery includes a shell, an electrode assembly, and an electrolyte. The electrode assembly and an electrolyte solution are both located in the shell.

The shell may be a packaging bag that is obtained by encapsulation with an encapsulation film (e.g., an aluminum-plastic film), for example, a pouch battery. In other examples, the secondary battery may also be a steel shell battery, an aluminum shell battery, etc.

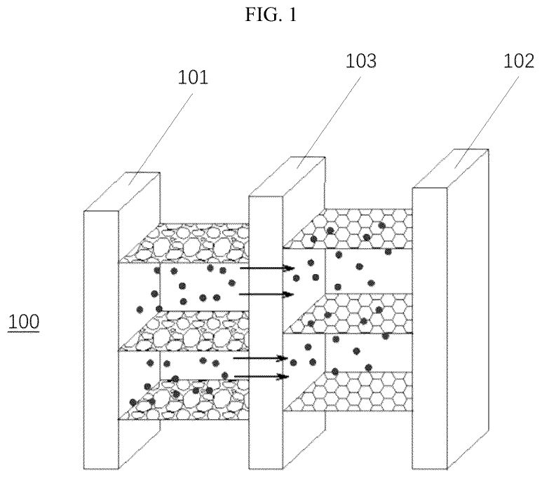

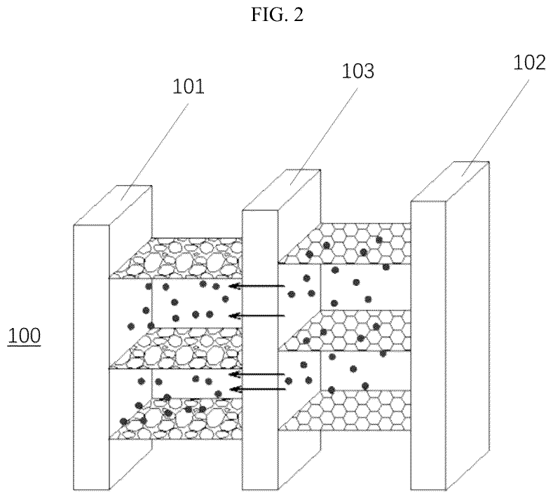

Referring to FIG. 1 and FIG. 2, the electrode assembly 100 includes a positive electrode plate 101, a negative electrode plate 102 and a separator 103, and the separator 103 is arranged between the positive electrode plate 101 and the negative electrode plate 102. During charging, referring to FIG. 1, active ions (e.g., lithium ions) are deintercalated from lattices of a cathode material (e.g., a lithiation intercalation compound) of the positive electrode plate 101, pass through the separator 103 through the electrolyte solution to reach the negative electrode plate 102, and then are intercalated into lattices of the anode material. During discharging, referring to FIG. 2, the active ions (e.g., lithium ions) are deintercalated from the lattices of the anode material of the negative electrode plate 102, pass through the separator 103 through the electrolyte solution to reach the positive electrode plate 101, and then are intercalated into the lattices of the cathode material (e.g., a lithiation intercalation compound), generated electrons reach the positive electrode plate 101 from the negative electrode plate 102 through an external circuit, and an electric current is formed by reverse movement of the electrons and can be used by electrical appliances.

In some examples, the electrode assembly 100 may be of a laminated structure, which is formed by sequentially and alternately laminating the positive electrode plate 101, the diaphragm 103 and the negative electrode plate 102. In other examples, the electrode assembly 100 may also be of a winding structure, which is formed by sequentially laminating and winding the positive electrode plate 101, the diaphragm 103 and the negative electrode plate 102.

The positive electrode plate 101 includes a positive current collector and a cathode active material layer arranged on at least one surface of the positive current collector. The positive current collector may use aluminum foil or nickel foil, etc., and may also be any composite current collector disclosed in the prior art, for example, but not limited to, a current collector formed by combination of the aforementioned conductive foil and a polymer substrate. The cathode active material layer includes a cathode active material, and the cathode active material includes a compound capable of reversibly intercalating and deintercalating lithium ions (i.e., a lithiation intercalation compound). In some examples, the cathode active material may include a lithium transition metal composite oxide. The lithium transition metal composite oxide contains lithium and at least one element selected from cobalt, manganese and nickel. In some examples, the cathode active material may include, but is not limited to, at least one of lithium cobaltate (LiCoO₂), a lithium nickel-manganese-cobalt ternary material (NCM), lithium manganate (LiMn₂O₄), lithium nickel manganate (LiNi_{0.5}Mn_{1.5}O₄), or lithium iron phosphate (LiFePO₄).

The cathode active material layer further includes a binder that is used for bonding cathode active material particles to facilitate the formation of a membrane layer and can also improve a binding force between the cathode active material layer and the positive current collector. In some examples, the binder may include, but is not limited to, at least one of polyvinyl alcohol, hydroxypropyl cellulose, diacetyl cellulose, polyvinyl chloride, carboxylated polyvinyl chloride, polyvinyl fluoride, polymers containing ethylene oxide, polyvinylpyrrolidone, polyurethane, polytetrafluoroethylene, poly(1,1-difluoroethylene), polyethylene, polypropylene, styrene-butadiene rubber, acrylic (ester) styrene-butadiene rubber, epoxy resin, or nylon, etc.

The cathode active material layer may further include a conductive material, and the conductive material includes, but is not limited to, a carbon-based material, a metal-based material, a conductive polymer, or any combination thereof. In some examples, the carbon-based material may include, but is not limited to, natural graphite, artificial graphite, carbon black, acetylene black, Ketjen black, a carbon fiber, or any combination thereof. In some examples, the metal-based material may include, but is not limited to, metal powder or a metal fiber, such as copper, nickel, aluminum, or silver. In some examples, the conductive polymer may be a polyphenylene derivative.

The separator 103 includes a membrane layer with a porous structure, and a material of which includes, but is not limited to, at least one of polyethylene, polypropylene, polyvinylidene fluoride, polyethylene glycol terephthalate, polyimide, or aramid. For example, the separator 103 may be a polypropylene porous membrane, a polyethylene porous membrane, a polypropylene non-woven fabric, a polyethylene non-woven fabric, or a polypropylene-polyethylene-polypropylene porous composite membrane, etc.

The electrolyte has the effect of conducting ions between the positive electrode plate 101 and the negative electrode plate 102. The state of the electrolyte may be one or more of gel state, solid state, and liquid state. In some examples, the electrolyte adopts an electrolyte solution. The electrolyte solution has the effect of conducting active ions between the positive electrode plate 101 and the negative electrode plate 102. In some examples, the electrolyte solution includes a lithium salt and an organic solvent. The lithium salt may be selected from, but is not limited to, one or more of lithium hexafluorophosphate (LiPF₆), lithium tetrafluoroborate (LiBF₄), lithium hexafluorarsenate (LiAsF₆), lithium perchlorate (LiClO₄), lithium tetraphenylborate (LiB(C₆H₅)₄), lithium methanesulfonate (LiCH₃SO₃), lithium bis(fluorosulfonyl)imide (LiFSI), lithium bis(trifluoromethanesulfonyl)imide (LiTFSI), lithium trifluoromethanesulfonate (LiCF₃SO₃), lithium bis(trifluoromethylsulfonyl)imide (LiN(SO₂CF₃)₂), lithium tri(trifluoromethylsulfonyl)methide (LiC(SO₂CF₃)₃), lithium bis(oxalate)borate (LiBOB), and lithium difluorophosphate (LiPO₂F₂). For example, LiPF₆ is selected as the lithium salt, because it can provide high ionic conductivity and improve cycle characteristics. The organic solvent may be a carbonate compound, a carboxylic acid ester compound, an ether compound, a nitrile compound, another organic solvent, or a combination thereof. Examples of the carbonate compound include, but are not limited to, diethyl carbonate (DEC), dimethyl carbonate (DMC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), vinyl ethylene carbonate (VEC), fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

When the secondary battery is prepared, the positive electrode plate, the separator and the negative electrode plate are wound or laminated to obtain a battery cell, the battery cell is encapsulated in an aluminum-plastic film stamped and formed in advance, the encapsulated battery is dried to remove moisture, the electrolyte solution is injected into the dry battery, and the battery is subjected to aging, forming and secondary sealing to complete preparation of the secondary battery.

The present application is further described in detail below in conjunction with specific examples, and these examples shall not be construed as limiting the scope of protection as claimed by the present application.

### Example 1

A method for preparing an anode material in the present example includes the following steps:
S1, subjecting 20 kg of a graphite raw material (with a D50 volume-average particle size of 16 m) to heat preservation under the conditions of a temperature of 500° C. and an oxygen volume content of 5% for 3 h, and conducting cooling to room temperature to obtain graphite oxide;
S2, adding the graphite oxide and 2.2 kg of petroleum asphalt (with a softening point of 250° C.) into a VC mixer for mixing for 25 min, conducting heat treatment under a nitrogen atmosphere at 400° C. for 4 h after the uniform mixing, and conducting cooling to room temperature to obtain a complex;
S3, subjecting the complex to densification treatment, conducting press forming treatment in a hydraulic press with a pressure of the hydraulic press being 30 MPa for a pressure holding time of 0.5 min, conducting reciprocating treatment for 2 times, then conducting isostatic pressing densification treatment at a maximum isostatic pressing pressure of 70 MPa for a pressure holding time of 3 min, and conducting crushing to obtain an intermediate product; and
S4, subjecting the intermediate product to carbonization under a nitrogen atmosphere at 1,250° C. for 16 h, and conducting scattering, demagnetization and screening after the carbonization to obtain the anode material in the present example.

### Example 2

A method for preparing an anode material in the present example includes the following steps:
S1, subjecting 20 kg of a graphite raw material (with a D50 volume-average particle size of 16 m) to heat preservation under the conditions of a temperature of 450° C. and an oxygen volume content of 6% for 3 h, and conducting cooling to room temperature to obtain graphite oxide;
S2, adding the graphite oxide and 2.2 kg of coal tar pitch (with a softening point of 180° C.) into a VC mixer for mixing for 25 min, conducting heat treatment under a nitrogen atmosphere at 350° C. for 4 h after the uniform mixing, and conducting cooling to room temperature to obtain a complex;
S3, subjecting the complex to densification treatment, conducting press forming in a hydraulic press with a pressure of the hydraulic press being 20 MPa for a pressure holding time of 0.5 min, conducting reciprocating treatment for 2 times, then conducting isostatic pressing densification treatment at a maximum isostatic pressing pressure of 70 MPa for a pressure holding time of 3 min, and conducting crushing to obtain an intermediate product; and
S4, subjecting the intermediate product to carbonization under a nitrogen atmosphere at 1,250° C. for 14 h, and conducting scattering, demagnetization and screening after the carbonization to obtain the anode material in the present example.

### Example 3

A method for preparing an anode material in the present example includes the following steps:
S1, subjecting 20 kg of a graphite raw material (with a D50 volume-average particle size of 16 m) to heat preservation under the conditions of a temperature of 500° C. and an oxygen volume content of 6% for 3 h, and conducting cooling to room temperature to obtain graphite oxide;
S2, adding the graphite oxide and 1.6 kg of coal tar pitch (with a softening point of 180° C.) into a VC mixer for mixing for 25 min, conducting heat treatment under a nitrogen atmosphere at 350° C. for 3 h after the uniform mixing, and conducting cooling to room temperature to obtain a complex;
S3, subjecting the complex to densification treatment, conducting press forming in a hydraulic press with a pressure of the hydraulic press being 20 MPa for a pressure holding time of 0.5 min, conducting reciprocating treatment for 2 times, then conducting isostatic pressing densification treatment at a maximum isostatic pressing pressure of 60 MPa for a pressure holding time of 3 min, and conducting crushing to obtain an intermediate product; and
S4, subjecting the intermediate product to carbonization under a nitrogen atmosphere at 1,250° C. for 12 h, and conducting scattering, demagnetization and screening after the carbonization to obtain the anode material in the present example.

### Example 4

A method for preparing an anode material in the present example includes the following steps:
S1, subjecting 20 kg of a graphite raw material (with a D50 volume-average particle size of 14.5 μm) to heat preservation under the conditions of a temperature of 500° C. and an oxygen volume content of 5% for 3 h, and conducting cooling to room temperature to obtain graphite oxide;
S2, adding the graphite oxide and 2.2 kg of petroleum asphalt (with a softening point of 250° C.) into a VC mixer for mixing for 25 min, conducting heat treatment under a nitrogen atmosphere at 400° C. for 4 h after the uniform mixing, and conducting cooling to room temperature to obtain a complex;
S3, subjecting the complex to densification treatment, conducting press forming in a hydraulic press with a pressure of the hydraulic press being 30 MPa for a pressure holding time of 0.5 min, conducting reciprocating treatment for 2 times, then conducting isostatic pressing densification treatment at a maximum isostatic pressing pressure of 70 MPa for a pressure holding time of 3 min, and conducting crushing to obtain an intermediate product; and
S4, subjecting the intermediate product to carbonization under a nitrogen atmosphere at 1,250° C. for 16 h, and conducting scattering, demagnetization and screening after the carbonization to obtain the anode material in the present example.

### Example 5

A method for preparing an anode material in the present example includes the following steps:
S1, subjecting 20 kg of a graphite raw material (with a D50 volume-average particle size of 10 m) to heat preservation under the conditions of a temperature of 550° C. and an oxygen volume content of 5% for 3 h, and conducting cooling to room temperature to obtain graphite oxide;
S2, adding the graphite oxide and 2.2 kg of petroleum asphalt (with a softening point of 250° C.) into a VC mixer for mixing for 25 min, conducting heat treatment under a nitrogen atmosphere at 400° C. for 4 h after the uniform mixing, and conducting cooling to room temperature to obtain a complex;
S3, subjecting the complex to densification treatment, conducting press forming in a hydraulic press with a pressure of the hydraulic press being 30 MPa for a pressure holding time of 0.5 min, conducting reciprocating treatment for 2 times, then conducting isostatic pressing densification treatment at a maximum isostatic pressing pressure of 70 MPa for a pressure holding time of 3 min, and conducting crushing to obtain an intermediate product; and
S4, subjecting the intermediate product to carbonization under a nitrogen atmosphere at 1,250° C. for 16 h, and conducting scattering, demagnetization and screening after the carbonization to obtain the anode material in the present example.

### Example 6

A method for preparing an anode material in the present example includes the following steps:
S1, subjecting 20 kg of a graphite raw material (with a D50 volume-average particle size of 16 m) to press forming in a hydraulic press with a pressure of the hydraulic press being 40 MPa for a pressure holding time of 0.5 min, conducting reciprocating treatment for 3 times, conducting crushing to an average particle size of 16 m after the press forming, then conducting isostatic pressing densification treatment at a maximum isostatic pressing pressure of 80 MPa for a pressure holding time of 3 min, and conducting crushing to obtain an intermediate product; and
S2, adding the intermediate product and 2.2 kg of asphalt (with a softening point of 250° C.) into a VC mixer for mixing for 25 min, conducting carbonization under a nitrogen atmosphere at 1,250° C. for 16 h after the uniform mixing, and conducting scattering, demagnetization and screening after the carbonization to obtain the anode material in the present example.

### Example 7

A method for preparing an anode material in the present example includes the following steps:
S1, subjecting 20 kg of a graphite raw material (with a D50 volume-average particle size of 16 m) to press forming in a hydraulic press with a pressure of the hydraulic press being 30 MPa for a pressure holding time of 0.5 min, conducting reciprocating treatment for 3 times, conducting crushing to an average particle size of 16 m after the press forming, then conducting isostatic pressing densification treatment at a maximum isostatic pressing pressure of 100 MPa for a pressure holding time of 3 min, and conducting crushing to obtain an intermediate product; and
S2, adding the intermediate product and 2.2 kg of asphalt (with a softening point of 250° C.) into a VC mixer for mixing for 25 min, conducting carbonization under a nitrogen atmosphere at 1,250° C. for 18 h after the uniform mixing, and conducting scattering, demagnetization and screening after the carbonization to obtain the anode material in the present example.

### Comparative Example 1

A method for preparing an anode material in the present comparative example includes the following steps:
adding 20 kg of a graphite raw material (with a D50 volume-average particle size of 16 m) and 2.2 kg of asphalt (with a softening point of 250° C.) into a VC mixer for mixing for 25 min, conducting carbonization under a nitrogen atmosphere at 1,250° C. for 16 h after completion of the material mixing, and conducting scattering, demagnetization and screening after the carbonization to obtain the anode material in the present comparative example.

### Comparative Example 2

A method for preparing an anode material in the present comparative example includes the following steps:
adding 20 kg of a graphite raw material (with a D50 volume-average particle size of 10 m) and 2.2 kg of asphalt (with a softening point of 250° C.) into a VC mixer for mixing for 25 min, conducting carbonization under a nitrogen atmosphere at 1,250° C. for 16 h after completion of the material mixing, and conducting scattering, demagnetization and screening after the carbonization to obtain the anode material in the present comparative example.

### Comparative Example 3

A method for preparing an anode material in the present comparative example includes the following steps:
S1, adding 20 kg of a graphite raw material (with a D50 volume-average particle size of 16 m) and 1.4 kg of petroleum asphalt (with a softening point of 120° C.) into a VC mixer for mixing for 25 min, conducting heat treatment under a nitrogen atmosphere at 400° C. for 4 h after the uniform mixing, and conducting cooling to room temperature to obtain a complex;
S2, subjecting the complex to densification treatment, conducting press forming in a hydraulic press with a pressure of the hydraulic press being 20 MPa for a pressure holding time of 0.5 min, conducting reciprocating treatment for 2 times, then conducting isostatic pressing densification treatment at a maximum isostatic pressing pressure of 50 MPa for a pressure holding time of 3 min, and conducting crushing to obtain an intermediate product; and
S3, subjecting the intermediate product to carbonization under a nitrogen atmosphere at 1,250° C. for 14 h, and conducting scattering, demagnetization and screening after the carbonization to obtain the anode material in the present comparative example.

### Comparative Example 4

A method for preparing an anode material in the present comparative example includes the following steps:
S1, subjecting 20 kg of a graphite raw material (with a D50 volume-average particle size of 16 m) to press forming in a hydraulic press with a pressure of the hydraulic press being 30 MPa for a pressure holding time of 0.5 min, conducting reciprocating treatment for 3 times, conducting crushing to an average particle size of 16 m after the press forming, then conducting isostatic pressing densification treatment at a maximum isostatic pressing pressure of 120 MPa for a pressure holding time of 3 min, and conducting crushing to obtain an intermediate product; and
S2, adding the intermediate product and 2.2 kg of asphalt (with a softening point of 180° C.) into a VC mixer for mixing for 25 min, conducting carbonization under a nitrogen atmosphere at 1,250° C. for 14 h after the uniform mixing, and conducting scattering, demagnetization and screening after the carbonization to obtain the anode material in the present comparative example.

### Test Example

### 1. Particle Hardness (HIT) and Elastic Modulus (EIT) Tests

The particle hardness (HIT) and elastic modulus (EIT) tests were carried out on the anode materials by using an Anton Paar NHT2 nanoindenter. The anode materials were placed on a sample stage of the nanoindenter adopting a static displacement mode and using a glass-type triangular pyramid indenter, the indenter was allowed to contact samples and loaded at a set rate until a set indentation depth was 1,200 nm, a load was maintained for a time of 15 s after the set depth was reached, and then the load was unloaded at the same rate, wherein a pressure loading and relieving rate was 5 mN/min, and a Poisson's ratio was 0.3.

The particle hardness was calculated according to the indentation depth and the magnitude of the load, and the elastic modulus was calculated according to a slope of a fitting line of an unloading curve ranging from 40%-98%. 10 particles were measured for each sample, and a mean value was taken after the tests.

### 2. Tablet Orientation Test

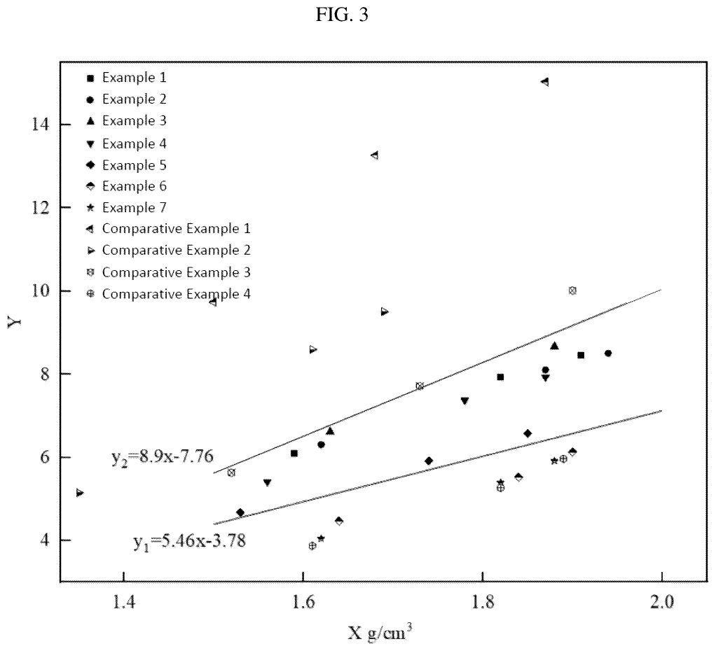

The anode materials, a carboxymethyl cellulose solution and a styrene-butadiene rubber solution were mixed at a mass ratio of 19.3:25:0.8, wherein a concentration of styrene-butadiene rubber in the styrene-butadiene rubber solution was 50 wt %, and a concentration of carboxymethyl cellulose in the carboxymethyl cellulose solution was 1.2 wt %. Uniform dispersion was conducted by using a high-speed disperser to obtain slurries. The slurries were evenly coated on a surface of aluminum foil and then placed in a constant-temperature drying oven for drying at a temperature of 80° C.-95° C. for more than 6 h until the slurries were completely dry to obtain samples to be tested. After the samples to be tested were ground to 200 mesh, pressures were applied to the samples by using a tablet press at 0.5 T (ton), 1 T (ton), and 2 T (ton) to obtain sheet-shaped samples (tablets), respectively. The tablets were placed under a thickness gauge to obtain initial thicknesses of the tablets after 10 s, then, the tablets were placed in a constant-temperature environment (25±3° C.) for standing for 16 h, thicknesses of the tablets after rebounding (after the standing for 16 h) were measured by using a micrometer, and tablet compaction densities at the corresponding pressures were calculated according to masses of the tablets, the initial thicknesses and the thicknesses after the rebounding. The tablets were analyzed by using an X-ray diffractometer to obtain crystal structures and orientations. By analyzing an X-ray diffraction pattern, orientations and corresponding peak areas of crystal faces were obtained, and an OI value was calculated as follows: tablet orientation OI value=I004/I110, wherein 1004 was a diffraction peak area of a crystal face (004) in the X-ray diffraction pattern, and I110 was a diffraction peak area of a crystal face (110) in the X-ray diffraction pattern. Test results are shown in FIG. 3 and Table 1. In Table 1, x represents the tablet compaction density, and y represents the tablet orientation OI value. In FIG. 3, X represents the tablet compaction density, and Y represents the tablet orientation OI value.

### 3. Particle Size Test

The D50 volume-average particle size (D1) and equal volume-average particle size (D2) of the anode materials were tested respectively by using a Malvern 3000 laser particle size analyzer. Samples, a small amount of a dispersing agent (a mixture of ethanol, pure water and a low-foaming surfactant) and pure water were added into a 50 mL beaker and thoroughly stirred with a glass rod to ensure uniform dispersion of the samples. The samples were transferred into a sample pool of the Marvin 3000 laser particle size analyzer, and the particle size test was carried out by setting a rotation speed of an equipment pump to 2,400 r/min-2,500 r/min and a frequency to 19.5 Hz.

### 4. Sphericity Sh(90%) Test

The sphericity of the anode materials was tested by using a QICPIC dynamic particle image analyzer of SYMPATEC. The sphericity Sh(90%) of the anode material refers to the sphericity corresponding to the 90% of the frequency cumulative distribution in the sphericity-frequency cumulative distribution curve.

### 5. Specific Surface Area (SSA) Test

The specific surface area test was carried out on the anode materials by using JW-DX dynamic specific surface area measuring equipment. With relevant theories of physical adsorption as bases and a continuous flow method proposed by Nelsen and Eggertsen as a structure, a specific surface area of a solid was determined. A mixed gas with hydrogen as a carrier and nitrogen as an adsorption gas was introduced into a sample tube. When the sample tube was immersed in liquid nitrogen to reach a low-temperature environment, the nitrogen in the mixed gas was physically adsorbed by samples until adsorption saturation was reached. At this time, a proportion of the nitrogen in the mixed gas was changed. During the adsorption, detection and calculation work were completed by a high-precision thermal conductivity detector.

### 6. Tap Density (Tap) Test

The tap density test was carried out on the anode materials by using a Quantachrome Dual Autotap device. 100 mL of an anode material sample was placed in a measuring cylinder and mechanically vibrated for 1,000 times, a sample mass and a volume after vibration were obtained, and the tap density was calculated as follows: tap density (g/cm³)=sample mass/volume after vibration.

### 7. Powder Compaction Density Test

1.0±0.05 g of the anode materials were introduced into a metal sleeve, and the sleeve loaded with the samples was placed in the center of a compaction density meter CARVER 4350.22. A pressure was slowly applied to 2 T (tons), continuous pressurization was stopped, a second hand was started, and the pressure was quickly removed after a pressure holding time of 30 s. The samples were taken out of a metal mold cavity and plated on a horizontal worktable of a thickness gauge to measure heights after compaction with the thickness gauge, and the powder compaction density was calculated as follows: powder compaction density (g/cm³)=sample mass/volume after compaction.

### 8. Initial Coulombic Efficiency Test

The anode materials in examples and comparative examples, carboxymethyl cellulose and styrene-butadiene rubber were respectively dissolved in pure water at a mass ratio of 96.5:1.5:2 to obtain negative slurries with a solid content controlled at 50%, the negative slurries were coated on copper foil current collectors and subjected to vacuum drying at 95° C., rolling and stamping to obtain negative electrode plates, and button batteries were assembled in a glove box filled with argon with a metallic lithium sheet as a counter electrode.

A charge and discharge test was carried out on the button batteries at a current density of 0.1 C and a charge-discharge interval of 0.01-1.5 V to obtain an initial reversible specific capacity, a first-cycle charge capacity and a first-cycle discharge capacity, respectively, and the initial coulombic efficiency was calculated as follows: initial coulombic efficiency=first-cycle discharge capacity/first-cycle charge capacity.

### 9. Cycle Stability Test

Large monocrystalline lithium nickel cobalt manganate (NCM523), conductive carbon black and polyvinylidene fluoride (PVDF) were mixed at a mass ratio of 94:3.0:3.0 and dissolved in N-methylpyrrolidone to obtain a positive slurry with a solid content controlled at 50%, and the positive slurry was coated on an aluminum foil current collector and subjected to vacuum drying at 95° C., rolling and stamping to obtain a positive electrode plate.

The anode materials in examples and comparative examples, carboxymethyl cellulose, styrene-butadiene rubber and conductive carbon black were respectively dissolved in N-methylpyrrolidone at a mass ratio of 95:1.5:2.1:1.2 to obtain negative slurries with a solid content controlled at 50%, and the negative slurries were coated on copper foil current collectors and subjected to vacuum drying at 95° C., rolling and stamping to obtain negative electrode plates.

The positive electrode plate, a separator and the negative electrode plates were assembled into lithium-ion batteries, and an electrolyte solution was injected to obtain pouch batteries of about 40 mAh, wherein the electrolyte solution contained 1 mol/L LiPF₆ and solvent, the solvent contained ethylene carbonate (EC), propylene carbonate (PC), diethyl carbonate (DEC) and ethyl methyl carbonate (EMC) at a volume ratio of 1:0.3:1:1, and the separator was a PP/PE/PP three-layer composite separator.

The above pouch batteries were used for testing the cycle performance of the materials. Constant-current charging was conducted to 4.20 V at a charge rate of 1 C, then constant-voltage charging was conducted, an electric current was gradually decreased to 0.05 C, and then discharging was conducted to 2.75 V at a discharge rate of 1 C. Such charge-discharge cycle was repeated for 400 times. A discharge capacity Q1 during the first cycle and a discharge capacity Q400 during the 400th cycle were measured. A capacity retention rate after 400 cycles was calculated as follows: capacity retention rate after 400 cycles=Q400/Q1×10000.

Test results are shown in Table 1 and Table 2.

TABLE 1

| | 0.5 T | | 1.5 T | | 2.0 T | |
|---|---|---|---|---|---|---|
| | x | | x | | x | |
| Serial number | g/cm³ | y | g/cm³ | y | g/cm³ | y |
| Example 1 | 1.59 | 6.1 | 1.82 | 7.94 | 1.91 | 8.46 |
| Example 2 | 1.62 | 6.31 | 1.87 | 8.11 | 1.94 | 8.51 |
| Example 3 | 1.63 | 6.62 | 1.88 | 8.67 | 1.99 | 9.73 |
| Example 4 | 1.56 | 5.42 | 1.78 | 7.38 | 1.87 | 7.94 |
| Example 5 | 1.53 | 4.68 | 1.74 | 5.92 | 1.85 | 6.58 |
| Example 6 | 1.61 | 4.48 | 1.82 | 5.53 | 1.87 | 6.14 |
| Example 7 | 1.62 | 4.05 | 1.82 | 5.40 | 1.88 | 5.92 |
| Comparative | 1.50 | 9.74 | 1.68 | 13.27 | 1.87 | 15.04 |
| Example 1 | | | | | | |
| Comparative | 1.35 | 5.15 | 1.60 | 8.60 | 1.69 | 9.51 |
| Example 2 | | | | | | |
| Comparative | 1.52 | 5.64 | 1.73 | 7.72 | 1.90 | 10.02 |
| Example 3 | | | | | | |
| Comparative | 1.61 | 3.88 | 1.82 | 5.27 | 1.89 | 5.97 |
| Example 4 | | | | | | |

TABLE 2

| | | | | | | | Powder | | | | | Capacity |
|---|---|---|---|---|---|---|---|---|---|---|---|---|
| | | | | | | | 2.0 T | | | | Initial | retention |
| | | | | | | | compaction | | | | coulombic | rate after |
| Serial | SSA | Tap | D1 | D2 | Sh | | density | HIT | EIT | Capacity | efficiency | 400 cycles |
| number | m²/g | g/cm³ | μm | μm | (90%) | Δ | g/cm³ | (GPa) | (GPa) | mAh/g | % | % |
| Example 1 | 2.42 | 1.179 | 16.9 | 17.4 | 0.92 | 0.05 | 1.862 | 0.335 | 7.26 | 362.6 | 94.97 | 95.22 |
| Example 2 | 2.68 | 1.105 | 17.1 | 17.7 | 0.92 | 0.04 | 1.904 | 0.308 | 7.45 | 363.1 | 94.92 | 93.98 |
| Example 3 | 3.72 | 1.089 | 16.7 | 17.3 | 0.91 | 0.06 | 1.953 | 0.287 | 7.9 | 363.6 | 94.66 | 92.52 |
| Example 4 | 2.88 | 1.201 | 14.5 | 15.1 | 0.94 | 0.03 | 1.797 | 0.356 | 7.15 | 362.8 | 94.84 | 95.38 |
| Example 5 | 2.79 | 1.102 | 10.6 | 11.2 | 0.94 | 0.04 | 1.770 | 0.393 | 7.08 | 362.3 | 94.54 | 95.67 |
| Example 6 | 2.87 | 1.049 | 16.7 | 17.4 | 0.92 | 0.04 | 1.872 | 0.288 | 7.78 | 360.9 | 94.08 | 90.45 |
| Example 7 | 2.79 | 1.098 | 16.8 | 17.6 | 0.91 | 0.04 | 1.886 | 0.295 | 7.96 | 360.2 | 94.13 | 90.98 |
| Comparative | 2.85 | 0.999 | 17.3 | 18.0 | 0.90 | 0.06 | 1.719 | 0.254 | 8.53 | 361.2 | 93.81 | 85.64 |
| Example 1 | | | | | | | | | | | | |
| Comparative | 3.37 | 1.040 | 10.9 | 11.2 | 0.90 | 0.07 | 1.606 | 0.342 | 8.72 | 360.8 | 93.50 | 87.56 |
| Example 2 | | | | | | | | | | | | |
| Comparative | 3.98 | 1.079 | 16.7 | 17.3 | 0.91 | 0.06 | 1.801 | 0.274 | 7.76 | 361.4 | 93.92 | 88.74 |
| Example 3 | | | | | | | | | | | | |
| Comparative | 2.67 | 1.102 | 16.9 | 17.4 | 0.92 | 0.05 | 1.894 | 0.297 | 7.98 | 360.1 | 94.22 | 90.01 |
| Example 4 | | | | | | | | | | | | |

In Table 2, D1 refers to the D50 volume-average particle size of the anode material, and D2 refers to the equal volume-average particle size of the anode material.

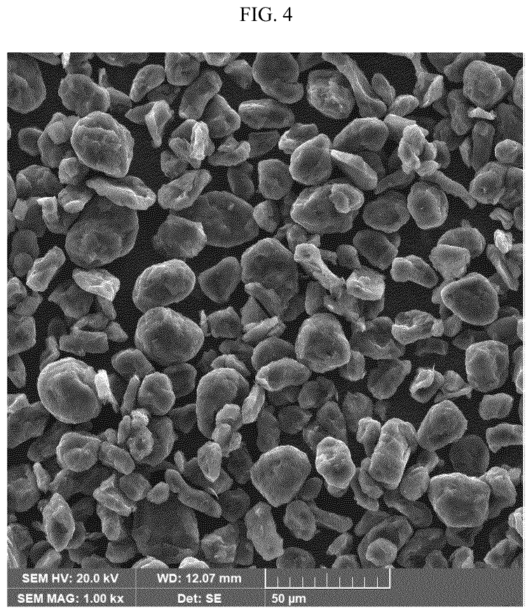

According to Table 1, Table 2, FIG. 3 and FIG. 4, it can be known that the anode materials in Examples 1-7 all satisfy that the particle hardness is 0.28 GPa-0.4 GPa, the elastic modulus is 7.0 GPa-8.0 GPa, the tablet orientation 01 value is y and 4<y≤11; the anode material in Comparative Example 1 does not satisfy that the particle hardness is 0.28 GPa-0.4 GPa, the elastic modulus is 7.0 GPa-8.0 GPa, the tablet orientation 01 value is y and 4<y≤11; the anode material in Comparative Example 2 does not satisfy that the elastic modulus is 7.0 GPa-8.0 GPa; the anode material in Comparative Example 3 does not satisfy that the particle hardness is 0.28 GPa-0.4 GPa; and the anode material in Comparative Example 4 does not satisfy the range of the tablet orientation 01 value when the compaction density is 1.61 g/cm³. Compared with Comparative Examples 1-4, the initial coulombic efficiency in Examples 1-7 is higher, the expansion performance is improved, the capacity retention rate after 400 cycles is high, and the overall electrical performance is better. Thus, it can be known that by making the materials satisfy that the particle hardness is 0.28 GPa-0.4 GPa, the elastic modulus is 7.0 GPa-8.0 GPa, the tablet orientation OI value is y and 4<y≤11 in the present application, the initial coulombic efficiency and the cycle stability can be significantly improved.

Further, compared with Examples 6-7, on the basis that the anode materials in Examples 1-5 satisfy that the particle hardness is 0.28 GPa-0.4 GPa, the elastic modulus is 7.0 GPa-8.0 GPa, the tablet orientation OI value is y and 4<y≤11, the anode materials in Examples 1-5 also further satisfy the following relationship: the tablet orientation OI values at different tablet compaction densities are all within the range of y₁y≤y₂, y₁=5.46x−3.78, and y₂=8.9x−7.76. The densification degree of the anode materials is further improved, and the structural stability is also further improved, so that the initial coulombic efficiency of the anode materials in Examples 1-5 is above 94%, the expansion performance is improved, and the capacity retention rate after 400 cycles is ≥92.5%, which are superior to those in Examples 6-7.

Further, compared with Example 3, on the basis that the anode materials in Examples 1, 2 and 4 satisfy that the particle hardness is 0.28 GPa-0.4 GPa, the elastic modulus is 7.0 GPa-8.0 GPa, the tablet orientation OI value is y, 4<y≤11, the tablet orientation OI values at different tablet compaction densities are all within the range of y₁<y≤y₂, y₁=5.46x−3.78 and y₂=8.9x−7.76, the anode materials in Examples 1, 2 and 4 also further satisfy that the tablet orientation OI value is 5-9. The filling rate and structural stability of the anode materials are further improved, and the volume expansion of the materials is further alleviated, so that the initial coulombic efficiency of the anode materials in Examples 1, 2 and 4 is above 94.84%, and the capacity retention rate after 400 cycles is ≥93.98%, which are superior to those in Example 3.

The statements above are merely preferred examples of the present application and are not intended to limit the present application, and for those skilled in the art, various modifications and alterations of the present invention can be made. Any modifications, equivalent substitutions, improvements and the like that are made within the spirit and principles of the present application shall be included in the scope of protection of the present application.

What is claimed is:

1. An anode material, wherein the anode material includes natural graphite and amorphous carbon filled in pores of the natural graphite; a particle hardness of the anode material is 0.28 GPa-0.4 GPa, and an elastic modulus is 7.0 GPa-8.0 GPa; and when a tablet compaction density of the anode material is 1.5 g/cm³-2.0 g/cm³, a tablet orientation OI value of the anode material is y, and 4<y≤11.

2. The anode material according to claim 1, wherein the tablet orientation OI value y of the anode material at different compaction densities satisfies the following condition: y₁<y≤y₂,
wherein y₁=5.46x−3.78, y₂=8.9x−7.76, 1.5≤x≤2.0, and x is a numerical value corresponding to the tablet compaction density of the anode material.

3. The anode material according to claim 1, wherein when the tablet compaction density of the anode material is 1.5 g/cm³-2.0 g/cm³, the tablet orientation OI value y of the anode material is 5-10.

4. The anode material according to claim 1, wherein the anode material satisfies at least one of the following characteristics:
(1) a sphericity Sh(90%) of the anode material is 0.90-0.95;
(2) a D50 volume-average particle size of the anode material is 8 μm-18 m; and
(3) an equal volume-average particle size of the anode material is 10 μm-20 μm.

5. The anode material according to claim 4, wherein a shape coefficient of the anode material is p, and the sphericity Sh(90%) of the anode material satisfies the following relationship: Δ=|φ−Sh(90%)|, and Δ≤0.08, wherein φ=D1/D2, D1 is the D50 volume-average particle size of the anode material with the unit of μm, and D2 is the equal volume-average particle size of the anode material with the unit of μm.

6. The anode material according to claim 1, wherein a specific surface area of the anode material is 2 m²/g-5 m²/g.

7. The anode material according to claim 1, wherein a tap density of the anode material is 0.9 g/cm³-1.3 g/cm³.

8. The anode material according to claim 1, wherein a powder compaction density of the anode material is 1.7 g/cm³-2.0 g/cm³.

9. A negative electrode plate, wherein the negative electrode plate includes the anode material according to claim 1.

10. A secondary battery, wherein the secondary battery includes the negative electrode plate according to claim 9.

11. The anode material according to claim 1, wherein the anode material satisfies at least one of the following characteristics:
(1) the particle hardness of the anode material is any value within any range of 0.28 GPa-0.295 GPa, 0.296 GPa-0.307 GPa, 0.308 GPa-0.356 GPa, 0.357 GPa-0.393 GPa, and 0.394 GPa-0.4 GPa;
(2) the elastic modulus of the anode material is any value within any range of 7.0 GPa-7.15 GPa, 7.16 GPa-7.26 GPa, 7.27 GPa-7.45 GPa, 7.46 GPa-7.78 GPa, and 7.79 GPa-8.0 GPa;
(3) when the tablet compaction density of the anode material is 1.5 g/cm³-2.0 g/cm³, the tablet orientation OI value of the anode material is any value within any range of 4.01-5.4, 5.53-6.58, 6.62-7.38, 7.94-8.51, 8.67-9.73, 9.74-10, and 10-11;
(4) the particle hardness of the anode material is 0.28 GPa, 0.287 GPa, 0.288 GPa, 0.295 GPa, 0.308 GPa, 0.335 GPa, 0.356 GPa, 0.393 GPa, 0.4 GPa or any value within any range comprised of two of the aforementioned values;
(5) the elastic modulus of the anode material is 7.0 GPa, 7.08 GPa, 7.15 GPa, 7.26 GPa, 7.45 GPa, 7.78 GPa, 7.9 GPa, 7.96 GPa, 8.0 GPa or any value within any range comprised of two of the aforementioned values; and
(6) when the tablet compaction density of the anode material is 1.5 g/cm³-2.0 g/cm³, the tablet orientation OI value of the anode material is 4.05, 4.48, 4.68, 5.4, 5.53, 5.92, 6.1, 6.31, 6.58, 6.62, 7.38, 7.94, 8.11, 8.46, 8.51, 8.67, 9.73, 10, 11 or any value within any range comprised of two of the aforementioned values.

12. The anode material according to claim 2, wherein the anode material satisfies at least one of the following characteristics:
(1) a sphericity Sh(90%) of the anode material is 0.90-0.95;
(2) a D50 volume-average particle size of the anode material is 8 μm-18 m; and
(3) an equal volume-average particle size of the anode material is 10 μm-20 μm.

13. The anode material according to claim 2, wherein a specific surface area of the anode material is 2 m²/g-5 m²/g.

14. The anode material according to claim 2, wherein a tap density of the anode material is 0.9 g/cm³-1.3 g/cm³.

15. The anode material according to claim 2, wherein a powder compaction density of the anode material is 1.7 g/cm³-2.0 g/cm³.

16. The negative electrode plate according to claim 9, wherein the tablet orientation OI value y of the anode material at different compaction densities satisfies the following condition: y₁≤y≤y₂,
wherein y₁=5.46x−3.78, y₂=8.9x−7.76, 1.5≤x≤2.0, and x is a numerical value corresponding to the tablet compaction density of the anode material.

17. The negative electrode plate according to claim 9, wherein when the tablet compaction density of the anode material is 1.5 g/cm³-2.0 g/cm³, the tablet orientation OI value y of the anode material is 5-10.

18. The negative electrode plate according to claim 9, wherein the anode material satisfies at least one of the following characteristics:
(1) a sphericity Sh(90%) of the anode material is 0.90-0.95;
(2) a D50 volume-average particle size of the anode material is 8 μm-18 m; and
(3) an equal volume-average particle size of the anode material is 10 μm-20 μm.

19. The negative electrode plate according to claim 16, wherein the anode material satisfies at least one of the following characteristics:
(1) a sphericity Sh(90%) of the anode material is 0.90-0.95;
(2) a D50 volume-average particle size of the anode material is 8 μm-18 m; and
(3) an equal volume-average particle size of the anode material is 10 μm-20 μm.

20. The negative electrode plate according to claim 18, wherein a shape coefficient of the anode material is φ, and the sphericity Sh(90%) of the anode material satisfies the following relationship: Δ=|φ−Sh(90%)|, and Δ≤0.08, wherein φ=D1/D2, D1 is the D50 volume-average particle size of the anode material with the unit of μm, and D2 is the equal volume-average particle size of the anode material with the unit of μm.
